(19) United States
(12) Patent Application Publication
(10) Pub. No.: US 2007/0285377 A1
(43) Pub. Date: Dec. 13, 2007

(54) Electro-optical device, circuit and method for driving the same, and electronic apparatus

(75) Inventor: Katsunori Yamazaki, Matsumoto-shi (JP)

Correspondence Address: OLIFF & BERRIDGE, PLC, P.O. BOX 19928, ALEXANDRIA, VA, 22320, US

(73) Assignee: EPSON IMAGING DEVICES CORPORATION, AZUMINO-SHI (JP)

(21) Appl. No.: 11/730,849

(22) Filed: Apr. 4, 2007

(30) Foreign Application Priority Data
May 2, 2006 (JP) 2006-128156
Feb. 5, 2007 (JP) 2007-025135

(51) Int. Cl. G09G 3/36

(52) U.S. Cl. 345/101

(57) ABSTRACT

A circuit for driving an electro-optical device including a plurality of pixels includes a look-up table that stores response-compensated data in accordance with supplied image data and image data of an immediately preceding frame, which is one frame before the frame of the supplied image data, a temperature sensor that detects an ambient temperature, and a calculation circuit that calculates response-compensated data corresponding to the temperature detected by the temperature sensor and that updates contents of the look-up table. Response-compensated data read from the look-up table according to a grayscale level specified by the supplied image data and a grayscale level specified by the image data of the immediately preceding frame is converted into a data signal, and the data signal is supplied to one of the pixels that corresponds to the supplied image data.

### BACKGROUND

1. Technical Field

The present invention relates to a technique for easily performing overdrive processing using a look-up table.

2. Related Art

Electro-optical materials, particularly liquid crystal, have a slow optical response to electrical changes. Therefore, electro-optical devices adapted to perform display using electro-optical changes of the liquid crystal have experienced a problem of poor moving-image display characteristics compared with other types of display devices such as cathode ray tubes (CRTs). JP-A-2001-265298 discloses so-called overdrive technology in which a grayscale level (voltage) specified by image data is compensated for the response using a look-up table by a grayscale level specified by image data of an immediately preceding frame.

The response speed (response) greatly depends on the temperature. JP-A-2004-133159 discloses a technique in which a plurality of look-up tables are provided in correspondence with different temperatures and one look-up table corresponding to a detected temperature is selected from among the look-up tables to perform overdrive processing.

The structure using a plurality of look-up tables, however, requires a large memory capacity for the look-up tables, and increases the circuit size. Therefore, a problem arises in that it is difficult to use the structure in compact and lightweight portable devices with large temperature variations.

### SUMMARY

An advantage of some aspects of the invention is that it provides an electro-optical device requiring only a small capacity for a look-up table and capable of enhancing the moving-image display characteristics, a circuit and method for driving the electro-optical device, and an electronic apparatus.

According to an aspect, the invention provides a circuit for driving an electro-optical device having a plurality of pixels, including a look-up table that stores response-compensated data in accordance with supplied image data and image data of an immediately preceding frame, which is one frame before the frame of the supplied image data; a temperature sensor that detects an ambient temperature; and a calculation circuit that calculates response-compensated data corresponding to the temperature detected by the temperature sensor and that updates contents of the look-up table, wherein response-compensated data read from the look-up table according to a grayscale level specified by the supplied image data and a grayscale level specified by the image data of the immediately preceding frame is converted into a data signal, and the data signal is supplied to one of the pixels that corresponds to the supplied image data. Since the contents of the look-up table are updated according to the temperature, only one look-up table is needed.

The calculation circuit may be configured to calculate a predetermined number of pieces of response-compensated data in a vertical blanking period or a horizontal blanking period, and to partially update the contents of the look-up table. In this case, the calculation circuit may also be configured to completely update the contents of the look-up table over a plurality of vertical blanking periods or horizontal blanking periods.

According to another aspect, the invention provides a method for driving the electro-optical device.

According to still another aspect, the invention provides the electro-optical device.

According to still another aspect, the invention provides an electronic apparatus including the electro-optical device.

### BRIEF DESCRIPTION OF THE DRAWINGS

The invention will be described with reference to the accompanying drawings, wherein like numbers reference like elements.

FIG. 1 is a block diagram showing the structure of an electro-optical device according to an embodiment of the invention.

FIG. 2 is a diagram showing the structure of an liquid crystal display (LCD) panel in the electro-optical device.

FIG. 3 is a diagram showing the structure of pixels in the LCD panel.

FIG. 4 is a diagram showing a look-up table in the electro-optical device.

FIG. 5 is a timing chart showing the operation of the electro-optical device.

FIG. 6 is a timing chart showing the operation of the electro-optical device.

FIG. 7 is a flowchart showing the operation of the electro-optical device.

FIG. 8 is a diagram showing a mobile phone, which is an example of an electronic apparatus including the electro-optical device.

### DESCRIPTION OF EXEMPLARY EMBODIMENTS

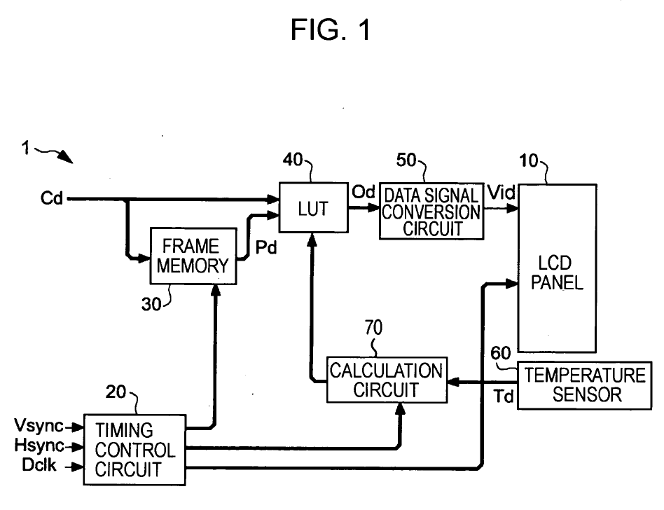

An embodiment of the invention will be described with reference to the drawings. FIG. 1 is a block diagram showing the structure of an electro-optical device 1 according to the embodiment.

As shown in FIG. 1, the electro-optical device 1 includes a liquid crystal display (LCD) panel 10, a timing control circuit 20, a frame memory 30, a look-up table (LUT) 40, a data signal conversion circuit 50, a temperature sensor 60, and a calculation circuit 70.

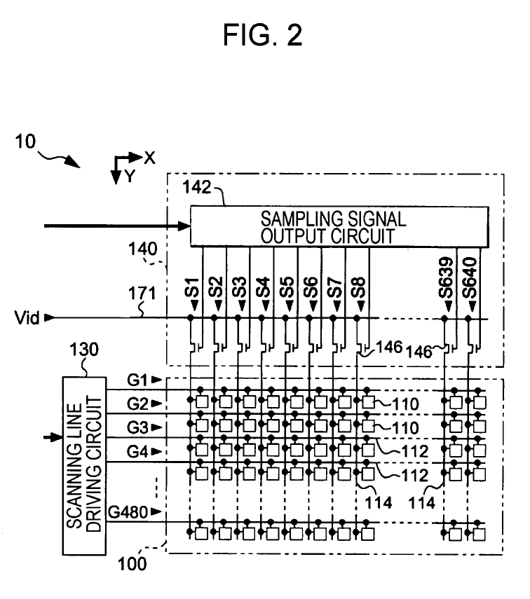

As shown in FIG. 2, the LCD panel 10 is of a peripheral circuit built-in type in which a scanning line driving circuit 130 and a data line driving circuit 140 are disposed around a display area 100. The display area 100 includes 480 scanning lines 112 extending in the row (X) direction, and 640 data lines 114 extending in the column (Y) direction so that the scanning lines 112 and the data lines 114 are electrically isolated from each other. The display area 100 further includes pixels 110 arranged at intersections of the 480 scanning lines 112 and the 640 data lines 114. In the embodiment, therefore, the pixels 110 are arranged in a matrix of 480 rows by 640 columns. However, the invention is not limited to this arrangement.

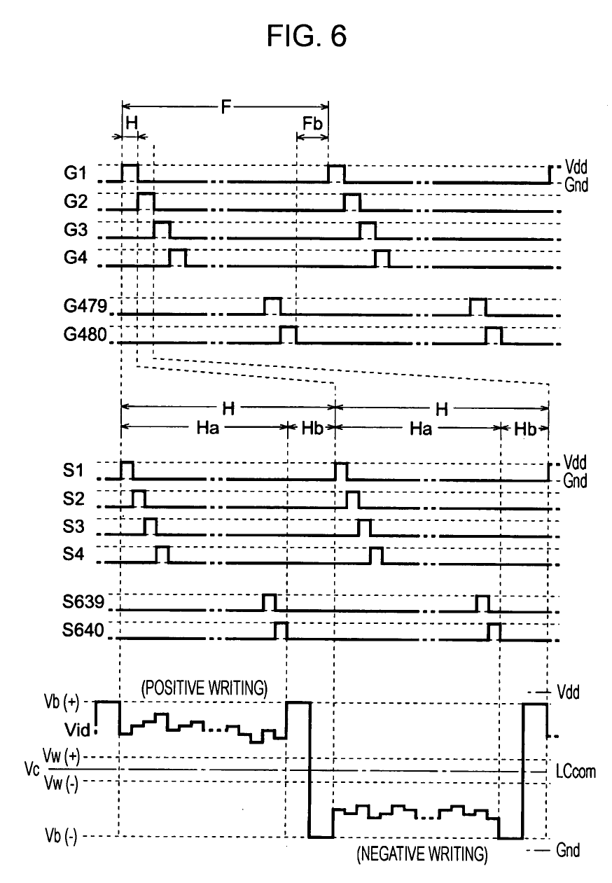

The scanning line driving circuit 130 supplies scanning signals G1, G2, G3, . . . , and G480 to the scanning lines 112 in the first, second, third, . . . , and 480th rows, respectively, according to the timing control circuit 20, described below. More specifically, as shown in FIG. 6, the scanning line driving circuit 130 sequentially selects the scanning lines 112 in the first, second, third, . . . , and 480th rows every horizontal scanning period (H), and supplies a high-level scanning signal to each of the selected scanning lines and a low-level scanning signal to the remaining scanning lines.

The data line driving circuit 140 includes a sampling signal output circuit 142 and thin film transistors (TFTs) 146 disposed for the respective data lines 114. As shown in FIG. 2, each time one of the scanning lines 112 is selected, the sampling signal output circuit 142 outputs sampling signals S1, S2, S3, . . . , and S640 that exclusively become a high level according to the timing control circuit 20.

The TFT 146 disposed for each of the columns has a drain connected to the data line 114 for the corresponding column, and a source commonly connected to an image signal line 171 to which a data signal Vid is supplied. A gate of the TFT 146 is supplied with the sampling signal for the corresponding column.

When the sampling signals S1, S2, S3, . . . , and S640 exclusively become the high level in this order within one horizontal scanning period (H) during which the scanning line 112 in a given row is selected, the TFTs 146 in the first, second, third, . . . , and 640th columns are sequentially turned on.

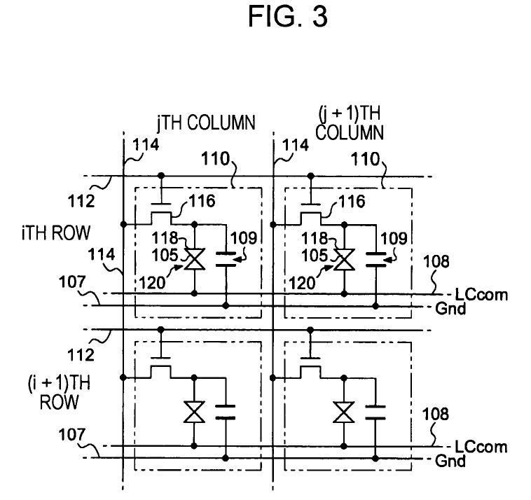

The structure of the pixels 110 will be described with reference to FIG. 3. FIG. 3 is a diagram showing the electrical structure of the pixels 110. In FIG. 3, an array of two pixels and two pixels, i.e., a total of four pixels, is illustrated. The four pixels are arranged at intersections of an i-th row and an (i+1)-th row adjacent thereto, which is one row below the i-th row, and a j-th column and a (j+1)-th column adjacent thereto, which is one column to the right of the j-th column.

The i-th and (i+1)-th rows generally represent rows in which the pixels 110 are arranged, where each of i and (i+1) denotes an integer ranging from 1 to 480. The j-th and (j+1)-th columns generally represent columns in which the pixels 110 are arranged, where each of j and (j+1) denotes an integer ranging from 1 to 640.

As shown in FIG. 3, each of the pixels 110 includes an n-channel TFT 116 and a liquid crystal capacitor 120. Since the pixels 110 have the same structure, the pixel 110 in the i-th row and the j-th column will be described by way of example. In the pixel 110 in the i-th row and the j-th column, the gate of the TFT 116 is connected to the scanning line 112 in the i-th row, and the source of the TFT 116 is connected to the data line 114 in the j-th column. The drain of the TFT 116 is connected to a pixel electrode 118, which is one terminal of the liquid crystal capacitor 120. The other terminal of the liquid crystal capacitor 120 is a common electrode 108 common to all the pixels 110, and a temporally constant voltage LCcom is applied to the common electrode 108.

The LCD panel 10 is configured such that a pair of substrates (not shown) including an element substrate and a counter substrate is bonded with a predetermined spacing (cell gap) therebetween and a liquid crystal is sandwiched between the pair of substrates. The scanning lines 112, the data lines 114, the TFTs 116, and the pixel electrodes 118 are defined on the element substrate, and the common electrode 108 is defined on the counter substrate. The element substrate and the counter substrate are bonded to each other so that the electrode-defining surfaces of the element substrate and the counter substrate face each other. Each of the liquid crystal capacitors 120 is configured such that a liquid crystal 105 is held between the pixel electrode 118 and the common electrode 108.

In the embodiment, for the convenience of illustration, a normally white mode is employed. That is, when the voltage effective values stored in the liquid crystal capacitors 120 are close to zero, the transmittance of light transmitted through the liquid crystal capacitors 120 becomes maximum so that white display is provided, whereas when the effective voltage values increase, the amount of transmitted light decreases and the transmittance finally becomes minimum so that black display is provided.

In the pixel 110 of interest, a high-level selection voltage is applied to the scanning line 112 to turn on the TFT 116 (so as to be brought into conduction). Further, a voltage corresponding to a grayscale level (brightness) is applied to the pixel electrode 118 via the data line 114 and the turned on TFT 116 to store the effective voltage value corresponding to the grayscale level in the liquid crystal capacitor 120.

When a low-level non-selection voltage is applied to the scanning line 112, the TFT 116 is turned off (so as to be brought into non-conduction). Since the off resistance at this time is not ideally infinite, some electric charges leak from the liquid crystal capacitor 120. In order to reduce the influence of the leakage, a storage capacitor 109 is provided for each pixel. One terminal of the storage capacitor 109 is connected to the pixel electrode 118 (the drain of the TFT 116), and the other terminal of the storage capacitor 109 is commonly connected to a capacitor line 107 common to all pixels. The capacitor line 107 is maintained at a temporally constant potential, e.g., a ground potential Gnd.

Referring back to FIG. 1, the timing control circuit 20 controls the respective components of the electro-optical device 1 in synchronization with a vertical synchronization signal Vsync, a horizontal synchronization signal Hsync, and a clock signal Dclk supplied from a higher-level circuit (not shown).

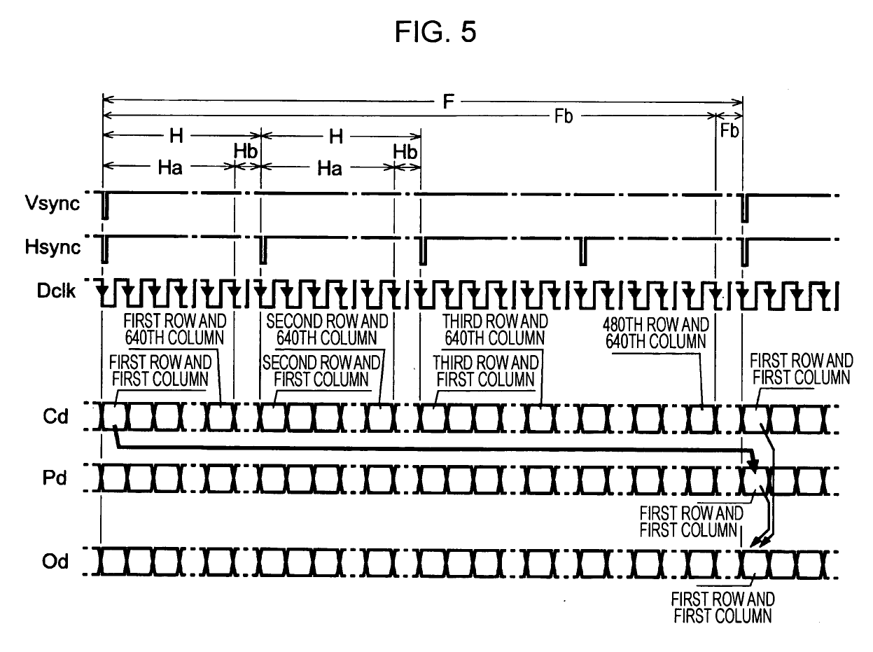

In the embodiment, image data Cd is six-bit digital data specifying grayscale levels of the pixels 110. As shown in FIG. 5, image data Cd corresponding to the pixels from the first row and the first column to the 480th row and the 640th column is supplied within one vertical scanning period (F) defined by the vertical synchronization signal Vsync. Image data Cd corresponding to the pixels in one row is supplied within one horizontal scanning period (H) defined by the horizontal synchronization signal Hsync. Image data Cd corresponding to one pixel is supplied at each dot clock Dclk.

The timing control circuit 20 controls the scanning line driving circuit 130 to select the scanning line 112 in the row corresponding to the supplied image data Cd. The timing control circuit 20 also controls the sampling signal output circuit 142 to output the sampling signal for the column corresponding to the supplied image data Cd.

The image data Cd supplied from the higher-level circuit specifies the grayscale levels (equal voltages) of the pixels. If the image data Cd is not processed and the voltages corresponding to the grayscale levels specified by the image data Cd are applied directly to the pixels 110 (the pixel electrodes 118), poor moving-image display characteristics are obtained due to the low response of the liquid crystal.

In the embodiment, therefore, the image data Cd is corrected by image data Pd of an immediately preceding frame using the look-up table 40, and the LCD panel 10 is driven by grayscale levels (voltages) based on the resulting image data (response-compensated data) Od compensated for the low response. The term frame as used in the embodiment means that all the pixels 110 constituting one screen are scanned, and a frame period is a period required to scan all the pixels 110, that is, one vertical scanning period (F).

The frame memory 30 stores the image data Cd and reads the image data Pd according to the timing control circuit 20. Specifically, the frame memory 30 stores the image data Cd supplied from the higher-level circuit, and reads and outputs, as the image data Pd, image data of the same pixel as that of the image data Cd, which is stored one vertical scanning period before.

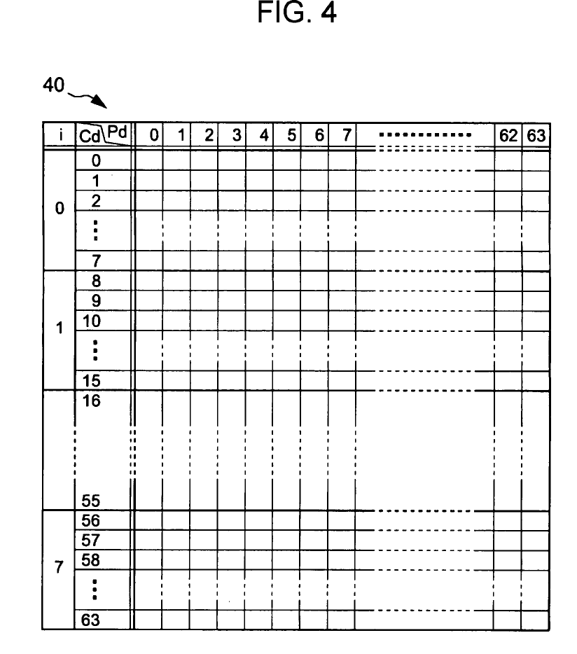

The look-up table 40 is a two-dimensional conversion table that compensates the grayscale levels specified by the image data Cd for the response according to the grayscale levels specified by the image data Pd and that outputs the response-compensated data as the image data Od. Specifically, in the embodiment, since the image data Cd is six-bit data, as shown in FIG. 4, the look-up table 40 stores in advance image data Od corresponding to each of 4096 types, which are combinations of 64 grayscale levels ranging from 0 to 63, which are specified by the image data Cd, and 64 grayscale levels, which are specified by the image data Pd. When image data Cd and image data Pd are input, image data Od corresponding to a combination of the grayscale levels designated by the image data Cd and the image data Pd is output.

The temperature sensor 60 detects am ambient temperature of the display area 100 of the LCD panel 10, and outputs data Td indicating the detected temperature.

The calculation circuit 70 performs a calculation to determine the image data Od corresponding to the temperature indicated by the data Td, and updates (rewrites) the contents of the look-up table 40 in a vertical blanking period. The calculation process for determining the image data Od and the updating operation of the look-up table 40 are described below.

The data signal conversion circuit 50 converts the image data Od read from the look-up table 40 into a data signal Vid of a voltage that is higher or lower than the voltage LCcom of the common electrode 108 by the voltage corresponding to the grayscale level specified by the image data Od, and supplies the data signal Vid to the image signal line 171 (see FIG. 2) in the LCD panel 10.

Although not shown in the embodiment, a row inversion (line inversion) method in which the polarity of the data signal is inverted every scanning line is employed. Alternatively, column inversion, dot inversion, or frame inversion may be employed.

The operation of the electro-optical device 1 according to the embodiment will now be described. The electro-optical device 1 performs overdrive processing to compensate for the low response of the liquid crystal. The calculation of the image data Od and the update of the look-up table 40 are features of the embodiment. The overdrive processing will be briefly described before the features, namely, the calculation and the update, are described.

As shown in FIG. 5, first, image data Cd corresponding to the pixels in the first row and the first through 640th columns is supplied from the higher-level circuit within a horizontal effective scanning period Ha. The timing control circuit 20 stores the image data Cd in the frame memory 30, and reads from the frame memory 30 the image data Pd of an immediately preceding frame for the same pixels as those of the image data Cd. The image data Od corresponding to the grayscale value indicated by the image data Cd and the grayscale value indicated by the image data Pd is read from the look-up table 40. The data signal conversion circuit 50 converts the read image data Od into, for example, a positive data signal Vid.

Further, the timing control circuit 20 controls the scanning line driving circuit 130 so that the scanning signal G1 is at a high level for a period during which the image data Cd for the first row is supplied. The timing control circuit 20 also controls the sampling signal output circuit 142 so that the sampling signals S1, S2, S3, and S640 sequentially become a high level in synchronization with the supply of the image data Cd.

When a data signal Vid for the pixel in the first row and the first column is supplied to the image signal line 171, the sampling signal S1 is set to the high level. Thereby, the TFT 146 in the first column is turned on, and the data signal Vid is sampled to the data line 114 in the first column. Likewise, when data signals Vid for the pixels in the first row and the second, third, . . . , and 640th columns are supplied to the image signal line 171, the sampling signals S2, S3, . . . , and S640 are set to the high level. Thereby, the data signals Vid for the pixels in the first row and the second, third, . . . , and 640th columns are sampled to the data lines 114 for the second, third, and 640th columns, respectively.

When the scanning signal G1 is at the high level, all the TFTs 116 of the pixels 110 in the first row are turned on, and the voltages of the data signals Vid sampled to the data lines 114 are applied directly to the pixel electrodes 118. Accordingly, the liquid crystal capacitors 120 in the pixels in the first row and the first, second, third, and 640th columns store the voltages specified by the image data Od, that is, positive voltages compensated for the response so that the average grayscale level within one frame period is equal to the grayscale level specified by the image data Cd.

In the invention, a driving circuit for converting the image data Od into a data signal Vid and supplying the data signal Vid to the pixels 110 is formed of the data signal conversion circuit 50, the scanning line driving circuit 130, and the data line driving circuit 140.

After a horizontal blanking period Hb has elapsed, image data Cd corresponding to the pixels in the second row and the first through 640th columns is supplied in the next horizontal effective scanning period Ha. The image data Cd for the second row is supplied by performing a similar operation to that for the first row. However, since the embodiment employs the row inversion, the liquid crystal capacitors 120 of the pixels in the second row and the first, second, third, . . . , and the 640th columns store the voltages specified by the image data Od, that is, negative voltages compensated for the response so as to provide the grayscale level specified by the image data Cd.

Thereafter, a similar operation is repeated until image data Cd for the 480th row has been supplied. Accordingly, the liquid crystal capacitors 120 of the pixels in the odd-numbered (first, third, fifth, . . . , and 479th) rows store response-compensated positive voltages, and the liquid crystal capacitors 120 of the pixels in the even-numbered (second, fourth, sixth, . . . , 480th) rows store response-compensated negative voltages.

In principle, the liquid crystal capacitors 120 are driven by an alternating current (AC). Thus, the polarity of a data signal is inverted when one or more predetermined frame periods have elapsed.

As shown in FIG. 6, in the positive writing, the data signal Vid is set to a voltage within a range from a voltage Vb(+) corresponding to black (minimum grayscale level) to a voltage Vw(+) corresponding to white (maximum grayscale level), which is higher than the voltage LCcom by the value specified by the image data Od. In the negative writing, the data signal Vid is set to a voltage within a range from a voltage Vb(−) corresponding to black to a voltage Vw(−) corresponding to white, which is lower than the voltage LCcom by the value specified by the image data Od. The positive voltage Vb(+) and the negative voltage Vb(−) are symmetrical to each other with respect to the voltage LCcom. The same applies to the voltages Vw(+) and Vw(−).

Of the logic levels of the scanning signals and the sampling signals, the high level represents a power supply voltage Vdd, and the low level represents the ground potential Gnd, which is a reference voltage in the embodiment. However, the polarity of the data signal Vid as used in the embodiment refers to the writing polarity to the liquid crystal capacitors 120, and the positive or negative determination is based on the voltage LCcom applied to the common electrode 108, rather than the ground potential Gnd. In FIG. 6, the vertical scale representing the voltage of the data line Vid is magnified compared with the other voltage waveforms.

In the embodiment, the polarity of the data signal Vid is based on the voltage LCcom applied to the common electrode 108. Due to parasitic capacitances between the gates and drains of the TFTs 116, there may occur a phenomenon (which is referred to as push-down, punch-through, field-through, or the like) in which the potentials of the drains of the TFTs 116 (the pixel electrodes 118) decrease when the state of the TFTs 116 changes from the on state to the off state. The AC driving is basically performed for the liquid crystal capacitors 120 in order to prevent degradation of the liquid crystal. However, when the AC driving is performed using the voltage LCcom applied to the common electrode 108 as a reference that the writing polarity is based on, due to the push-down phenomenon, the effective voltage values of the liquid crystal capacitors 120 in the negative writing are slightly greater than the effective voltages in the positive writing (if the TFTs 116 are n-channel transistors). Thus, unless the push-down phenomenon is negligible, the polarity of the data signal Vid is based on a voltage higher than the voltage LCcom so that the influence of the push-down phenomenon can be canceled.

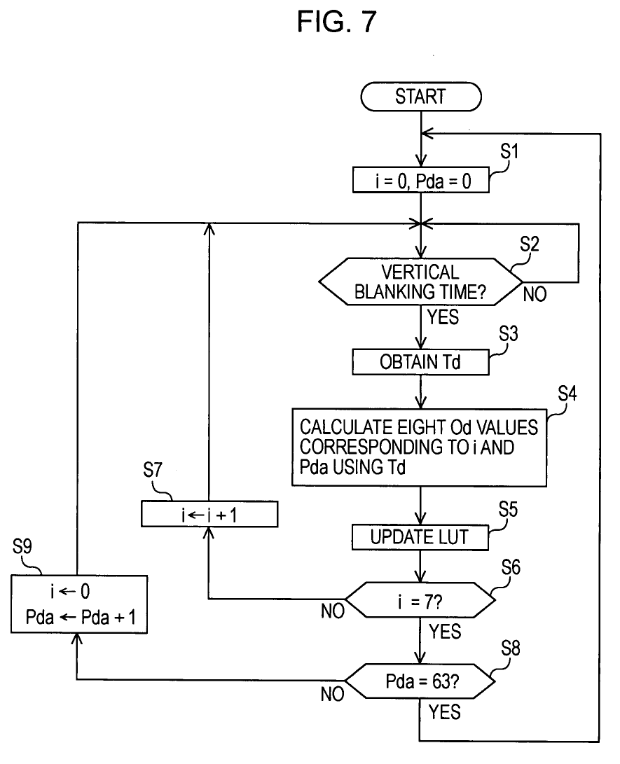

The features of the embodiment, namely, the calculation of the image data Od and the update of the look-up table 40, will now be described. FIG. 7 is a flowchart showing a process for updating the look-up table 40.

First, in step S1, the calculation circuit 70 resets variables i and Pda to an initial value of zero. In the look-up table 40 shown in FIG. 4, the grayscale values of the image data Cd ranging from 0 to 63 are divided into eight blocks, i.e., a block of grayscale values of 0 to 7, a block of grayscale values of 8 to 15, a block of grayscale values of 16 to 23, . . . , and a block of grayscale values of 56 to 63, which are assigned numbers 0, 1, 2, . . . , and 7, respectively. The variable i corresponds to the blocks 0 to 7. The variable Pda corresponds to the grayscale values of the image data Pd ranging from 0 to 63. In the embodiment, eight pieces of image data Od to be calculated are defined by the variables i and Pda.

For example, when the variables i and Pda have an initial value of zero, eight pieces of image data Od defined by image data Cd having grayscale values of 0 to 7 and image data Pd having a grayscale value of 0 are to be calculated. When the variables i and Pda are set to, for example, 1 and 3, respectively, eight pieces of image data Od defined by image data Cd having grayscale values of 8 to 15 and image data Pd having a grayscale value of 3 are to be calculated.

In step S2, the calculation circuit 70 determines whether or not the time during which the timing control circuit 20 is scanning the LCD panel 10 is a vertical blanking period. The vertical blanking period is a period Fb shown in FIG. 5, which is a period from the supply of the image data Cd corresponding to the last pixel in the 480th row and the 640th column to the supply of the image data Cd corresponding to the first pixel in the first row and the first column. In the vertical scanning period (F), a period Fa except for the vertical blanking period (Fb) corresponds to a vertical active display period.

The calculation circuit 70 waits for the vertical blanking period without starting the subsequent process. When the vertical blanking period has arrived, in step 3, the calculation circuit 70 obtains data Td indicating an ambient temperature from the temperature sensor 60.

Upon obtaining the data Td, in step S4, the calculation circuit 70 performs a calculation described below to determine eight pieces of image data Od corresponding to the variables i and Pda from the temperature indicated by the data Td (more specifically, the liquid crystal viscosity corresponding to the temperature, as described below).

In step S5, the calculation circuit 70 updates the eight pieces of image data Od indicated by the variables i and Pda in the look-up table 40 into the obtained eight pieces of image data Od. The updated image data Od therefore reflects the temperature currently detected by the temperature sensor 60.

In step S6, the calculation circuit 70 determines whether or not the current value of the variable i is the maximum value of 7. If the value of the variable i is not 7, in step S7, the calculation circuit 70 increments the variable i by one. In the next vertical blanking period, therefore, eight pieces of image data Od defined by image data Cd corresponding to the variable i whose value is incremented and the variable Pda whose value is the same are obtained.

If the value of the variable i is 7, in step S8, the calculation circuit 70 determines whether or not the current value of the variable Pda is the maximum value of 63. If the value of the variable Pda is not 63, in step S9, the calculation circuit 70 resets the variable i to zero, and increments the variable Pda by one. In the next vertical blanking period, therefore, eight pieces of image data Od defined by image data Cd having grayscale values of 0 to 7 and the variable Pda whose value is incremented are obtained. If the current value of the variable Pda is 63, all the 4096 pieces of image data Od in the look-up table 40 have been updated, and the calculation circuit 70 returns the process to step S1. In the next vertical blanking period, therefore, the look-up table 40 is updated again starting from the eight pieces of image data Od defined by the image data Cd having grayscale values of 0 to 7 and the image data Pd having a gray value of 0.

The calculation performed in step S4 will now be described.

First, when a voltage (difference voltage between the pixel electrode 118 and the common electrode 108) V is applied to the liquid crystal capacitor 120 at a certain time, a capacitance Cₚᵢₓ[V, t] at a time when t seconds have elapsed since that time is given by the following equation (1):

$$\begin{matrix}{C}_{pix} [ V , t ] = \frac{{C}_{pix} [ V , ∞ ]}{\sqrt{1 + ( \frac{{C}_{pix}^{2} [ V , ∞ ]}{{C}_{pix}^{2} [ V , 0 ]} - 1 )} \cdot Exp ( - \frac{t}{τ} )} \\ where & ( 1 ) \\ τ = {t}_{on} [ V ] = \frac{γ \cdot {d}^{2}}{{ɛ}_{0} \cdot Δɛ \cdot {V}^{2} \cdot {π}^{2} K} \\ when the voltage V applied to the \\ liquid crystal capacitor is high & ( 2 ) \\ τ = {t}_{off} [ V ] = \frac{γ \cdot {d}^{2}}{{π}^{2} K} \\ when the voltage V applied to the \\ liquid crystal capacitor is low {C}_{pix} [ V , 0 ] indicates the liquid crystal capacitance generated \\ when the voltage V is applied to the liquid crystal capacitor . {C}_{pix} [ V , ∞ ] indicates the final liquid crystal capacitance \\ generated when the voltage V is continuously applied to the \\ liquid crystal capacitor . & ( 3 )\end{matrix}$$

In equation (2) or (3), γ denotes the viscosity coefficient of the liquid crystal, K denotes the modulus of elasticity, d denotes the cell gap, Δε denotes the dielectric anisotropy of the liquid crystal, ε₀ denotes the dielectric constant in vacuum, and π denotes the circular constant.

When an applied voltage is high, the response time approaches infinity as the denominator of equation (2) approaches zero. A threshold voltage Vth is defined as below, and the liquid crystal does not move if an applied voltage is below the threshold voltage Vth.

$${V}_{th} ≡ \sqrt{\frac{K}{{ɛ}_{0} \cdot Δɛ}}$$

Directors indicating the local average orientation of the liquid crystal molecules and the capacitances Cpix of the liquid crystal capacitors 120 have one-to-one correspondence, and the directors and the transmittances (reflectances) of the liquid crystal capacitors 120 also have substantially one-to-one correspondence. Therefore, the transmittances (i.e., grayscale values) and the capacitances Cpix have one-to-one correspondence.

In equation (1), if the voltage corresponding to the grayscale level of the immediately preceding frame before the change is denoted by V_{Pd}, the voltage corresponding to the grayscale level after the change is denoted by V_{Cd}, and the response-compensated voltage is denoted by V_{Od}, it is sufficient that the capacitance Cₚᵢₓ[V_{Od}, th] obtained after the lapse of one frame period is equal to the capacitance Cₚᵢₓ[V_{Cd}, ∞] obtained when the voltage V_{Cd} corresponding to the grayscale level after the change is applied after the infinite time has elapsed. Therefore, the following equation (4) is established:

$${C}_{pix} [ {V}_{Od} , {t}_{h} ] = \frac{{C}_{pix} [ {V}_{Od} , ∞ ]}{\sqrt{1 + ( \frac{{C}_{pix}^{2} [ {V}_{Od} , ∞ ]}{{C}_{pix}^{2} [ {V}_{Pd} , ∞ ]} - 1 )} \cdot Exp ( - \frac{t}{τ} )} = {C}_{pix} [ {V}_{Cd} , ∞ ] \qquad ( 4 )$$

In equation (4), τ is also given by equations (2) and (3). The time tₕ after the lapse of one frame period is 16.7 ms (milliseconds) if the vertical scanning frequency is 60 Hz.

The final liquid crystal capacitance Cₚᵢₓ[V, ∞] obtained after the lapse of the infinite time can highly accurately be transformed into a function using a simple expression such as “a+b/V” if the voltage V is equal to or more than the threshold voltage Vth, where a and b are constants and are determined by a fitting procedure or the like.

By substituting the above-mentioned expression into equation (4), the following equation (5) is obtained:

$$\frac{a + \frac{b}{{V}_{Od}}}{\sqrt{1 + ( \frac{{( a + \frac{b}{{V}_{Od}} )}^{2}}{{( a + \frac{b}{{V}_{Pd}} )}^{2}} - 1 ) \cdot Exp ( - \frac{{t}_{h}}{τ} )}} = a + \frac{b}{{V}_{Cd}} \qquad ( 5 )$$

If equation (5) is solved for the voltage V_{Od}, the following equation (6) is obtained:

$$\begin{matrix}α = \frac{\begin{matrix}a ( {a}^{2} ( - 1 + Ex ) {V}_{Cd}^{2} {V}_{Pd}^{2} - 2 {abV}_{Cd} {V}_{Pd} ( {V}_{Cd} - {ExV}_{Pd} ) + \\ {b}^{2} ( - {V}_{Cd}^{2} + {ExV}_{Pd} ) )\end{matrix}}{\begin{matrix}{b}^{3} ( - 1 + Ex ) + 2 {a}^{3} {V}_{Cd} ( {ExV}_{Cd} - {V}_{Pd} ) {V}_{Pd} + \\ 2 {ab}^{2} ( - 1 + Ex ) ( {V}_{Cd} + {V}_{Pd} ) + {a}^{2} b ( - {V}_{Pd} ( 4 {V}_{Cd} + {V}_{Pd} ) + \\ {ExV}_{Cd} ( {V}_{Cd} + 4 {V}_{Pd} ) )\end{matrix}} \\ β = \frac{\sqrt{\begin{matrix}( - 1 + Ex ) {( b + {aV}_{Cd} )}^{2} {( b + {aV}_{Pd} )}^{2} ( {a}^{2} ( - 1 + Ex ) {V}_{Cd}^{2} {V}_{Pd}^{2} - \\ 2 {abV}_{Cd} {V}_{Pd} ( {V}_{Cd} - {ExV}_{Pd} ) + {b}^{2} ( - {V}_{Cd}^{2} + {ExV}_{Pd}^{2} ) )\end{matrix}}}{\begin{matrix}{b}^{3} ( - 1 + Ex ) + 2 {a}^{3} {V}_{Cd} ( {ExV}_{Cd} - {V}_{Pd} ) {V}_{Pd} + \\ 2 {ab}^{2} ( - 1 + Ex ) ( {V}_{Cd} + {V}_{Pd} ) + {a}^{2} b ( - {V}_{Pd} ( 4 {V}_{Cd} + {V}_{Pd} ) + \\ {ExV}_{Cd} ( {V}_{Cd} + 4 {V}_{Pd} ) )\end{matrix}} & \\ {V}_{OD} = \frac{2 b {Ex ( a + \frac{b}{{V}_{D 2}} )}^{2}}{\begin{matrix}{( a + \frac{b}{{V}_{D 1}} )}^{2} \pm ( a + \frac{b}{{V}_{D 1}} ) \\ \sqrt{{( a + \frac{b}{{V}_{D 1}} )}^{2} - 4 {Ex ( a + \frac{b}{{V}_{D 2}} )}^{4} + 4 {{Ex}^{2} ( a + \frac{b}{{V}_{D 2}} )}^{4}} - \\ 2 a {Ex ( a + \frac{b}{{V}_{D 2}} )}^{2}\end{matrix}} \\ where \\ Ex = Exp ( - \frac{t}{τ} ) & ( 6 )\end{matrix}$$

In the radical in the equation for β, a significant sign as a result of actual calculation is used.

Herein, only the time constant of the Ex term varies in accordance with the temperature. That is, the viscosity coefficient γ of the liquid crystal exponentially varies with respect to the temperature, and the response speed also varies. Since the characteristic of the viscosity coefficient γ with respect to the temperature can be measured by an experiment or the like, viscosity coefficients γ with respect to temperatures are determined in advance and stored in a table. The viscosity coefficient γ corresponding to the temperature indicated by the data Td can be used to determine the voltage V_{Od} by performing the calculation according to equation (6) above.

However, when the voltage is high, the equation below is established. Thus, the value V_{Od}, which is the solution, is introduced in the Ex term.

$$τ = {t}_{on} [ {V}_{Od} ] = \frac{γ \cdot {d}^{2}}{{ɛ}_{0} \cdot Δɛ \cdot {V}_{Od}^{2} \cdot {π}^{2} K}$$

Therefore, it is difficult to calculate the voltage V_{Od} using equation (6) above when the voltage is high. However, the solution can be found using appropriate iterative calculations by setting the voltage V in the time constant τ to a tentative value. For example, values greater and smaller than the tentative value are substituted, and the value with a smaller error in the equation given above is selected. This operation can be repeated until the error is within a predetermined value.

The response-compensated voltage V_{Od} can therefore be determined as a function of the voltage V_{Pd} corresponding to the grayscale level of an immediately preceding frame before the change, the voltage V_{Cd} corresponding to the grayscale level after the change, and the temperature T. While the foregoing description has been given in the context of the determination of a voltage, the look-up table 40 has a structure in which a grayscale level is input and data corresponding to the grayscale level is output. As is to be understood, since voltages and grayscale level values (transmittances) have one-to-one correspondence, it is sufficient to convert the determined voltage into a grayscale value. There will be required no special description of such an interconversion between voltages and grayscale values.

According to the embodiment, since eight pieces of image data Od are updated in a vertical blanking period, a period of 512 (=4096÷8) frames is required to update the contents of the look-up table 40. The period of 512 frames is approximately 8.5 seconds if the vertical scanning frequency is 60 Hz. In the embodiment, therefore, once the image data Od is updated, there occurs no change following a change in temperature for the period of approximately 8.5 seconds until the next iteration of the updating process. There is no problem with such a temperature following property because the temperature of the LCD panel 10 slowly changes even if the ambient temperature abruptly changes.

Further, according to the embodiment, since the image data Od calculated according to the ambient temperature is read from the look-up table, appropriate response compensation in accordance with the ambient temperature can be achieved. In addition, only one look-up table is needed for response compensation, and a simple structure can be realized.

Further, according to the embodiment, the 4096 pieces of image data Od in the look-up table 40 are not determined at the same time but are determined in units of eight pieces. Therefore, the calculation circuit 70 does not require high calculation performance, and the number of programs required for the calculation can be reduced.

In the embodiment, the calculation and update of the image data Od are performed in a vertical blanking period to avoid interference with the reading of the image data Od. Alternatively, those operations can be performed in a horizontal blanking period, or can be performed in both vertical and horizontal blanking periods. If the writing to and reading from the look-up table 40 do not interfere with each other, there is no problem in performing the calculation and update of the image data Od in a horizontal active display period.

Further, in the embodiment, depending on the detected temperature, response compensation may not be performed or the calculation and update of the image data Od may be stopped. For example, when the temperature detected by the temperature sensor 60 is outside a displayable temperature range, there is no need to perform response compensation.

Further, in the embodiment, the electro-optical device 1 is configured such that the image data Od is calculated according to the temperature. For example, a circuit external to the electro-optical device 1, such as the higher-level circuit that supplies the image data Cd defining an image to be displayed, may calculate the image data Od, and may directly supply the image data Od to the data signal conversion circuit 50 in the electro-optical device 1. Alternatively, upon receiving the image data Od calculated by the higher-level circuit, the electro-optical device 1 may update the contents of the look-up table 40.

Further, in the embodiment, the look-up table 40 stores a total of 4096 (=2⁶×2⁶) pieces of image data Od, which correspond to combinations of grayscale levels specified by six bits of the image data Cd and Pd. For example, the look-up table 40 may store a reduced number of pieces of image data Od, such as 256 (=2⁴×2⁴), which correspond to combinations of grayscale levels specified by only the four most significant bits of the image data Cd and Pd, wherein the two least significant bits are discarded. In this structure, the calculation circuit 70 can also perform a calculation to determine the image data Od in units of several pieces according to the temperature.

In the above-described embodiment, a dot sequential driving method is employed in which when a scanning signal corresponding to the scanning line 112 in a given row is at a high level, data signals Vid corresponding to the pixels in the given row and the first to 480th columns are sequentially supplied. The invention is not limited to this driving method, and other driving methods can be employed. For example, the dot sequential driving method can be used in combination with a phase expansion (also called serial-parallel conversion) driving method in which a data signal is expanded n times along the time axis (where n is an integer more than one) and is supplied to n image signal lines (see JP-A-2000-112437). Alternatively, a line sequential driving method can be employed in which data signals are supplied to all the data lines 114 at the same time.

Further, in the embodiment, a normally white mode in which white display is provided in a state where no voltage is applied is adopted. Instead of the normally white mode, a normally black mode in which black display is provided in a state where no voltage is applied may be adopted. Alternatively, one dot may be formed of three pixels of red (R), green (G), and blue (B), and color display may be performed. The display type of the display area 100 is not limited to the transmissive type, and the display area 100 may be of the reflective type or of the transflective type using both types.

The invention is not limited to liquid crystal display devices, and can be applied to any other display device designed to perform display using an electro-optical material having a low-speed optical response to electrical changes.

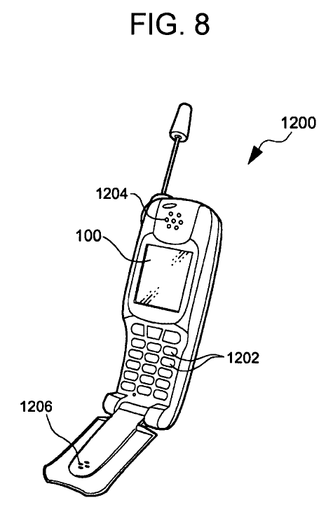

An electronic apparatus having the electro-optical device 1 according to the above-described embodiment will now be described. FIG. 8 is a diagram showing the structure of a mobile phone 1200 having the electro-optical device 1 according to an embodiment of the invention.

As shown in FIG. 8, the mobile phone 1200 includes a plurality of operation buttons 1202, an earpiece 1204, a mouthpiece 1206, and the electro-optical device 1 described above. Since the components of the electro-optical device 1, except for the display area 100, are received in the mobile phone 1200, and are therefore hidden from outside.

Examples of electronic apparatuses having the electro-optical device 1 include not only the mobile phone shown in FIG. 8 but also a digital still camera, a laptop personal computer, a liquid crystal television set, a viewfinder-type (or monitor direction-view type) videotape recorder, a car navigation system, a pager, an electronic organizer, an electronic calculator, a word processor, a workstation, a video telephone, a point-of-sale (POS) terminal, and an apparatus equipped with a touch panel. It is to be understood that the electro-optical device 1 described above can be used as a display device of those electronic apparatuses.

The entire disclosure of Japanese Patent Application Nos. 2006-128156, filed May 2, 2006 and 2007-025135, filed Feb. 5, 2007 are expressly incorporated by reference herein.

What is claimed is:

1. A circuit for driving an electro-optical device including a plurality of pixels, comprising:
a look-up table that stores response-compensated data in accordance with supplied image data and image data of an immediately preceding frame, which is one frame before the frame of the supplied image data;
a temperature sensor that detects an ambient temperature; and
a calculation circuit that calculates response-compensated data corresponding to the temperature detected by the temperature sensor and that updates contents of the look-up table,
wherein response-compensated data read from the look-up table according to a grayscale level specified by the supplied image data and a grayscale level specified by the image data of the immediately preceding frame is converted into a data signal, and the data signal is supplied to one of the pixels that corresponds to the supplied image data.

2. The circuit according to claim 1, wherein the calculation circuit calculates a predetermined number of pieces of response-compensated data in a vertical blanking period or a horizontal blanking period, and partially updates the contents of the look-up table.

3. The circuit according to claim 2, wherein the calculation circuit completely updates the contents of the look-up table over a plurality of vertical blanking periods or horizontal blanking periods.

4. A method for driving an electro-optical device including a plurality of pixels and a look-up table that stores response-compensated data in accordance with supplied image data and image data of an immediately preceding frame, which is one frame before the frame of the supplied image data, comprising:
detecting an ambient temperature;
calculating response-compensated data corresponding to the detected temperature and updating contents of the look-up table; and
converting response-compensated data read from the look-up table according to a grayscale level specified by the supplied image data and a grayscale level specified by the image data of the immediately preceding frame into a data signal and supplying the data signal to one of the pixels that corresponds to the supplied image data.

5. An electro-optical device comprising:
a plurality of pixels;
a look-up table that stores response-compensated data in accordance with supplied image data and image data of an immediately preceding frame, which is one frame before the frame of the supplied image data;
a temperature sensor that detects an ambient temperature;
a calculation circuit that calculates response-compensated data corresponding to the temperature detected by the temperature sensor and that updates contents of the look-up table; and
a driving circuit that converts response-compensated data read from the look-up table according to a grayscale level specified by the supplied image data and a grayscale level specified by the image data of the immediately preceding frame into a data signal, and that supplies the data signal to one of the pixels that corresponds to the supplied image data.

6. An electronic apparatus comprising the electro-optical device according to claim 5.
